(19) United States
(12) Patent Application Publication
(10) Pub. No.: US 2018/0124483 A1
(43) Pub. Date: May 3, 2018

(54) OPTICAL SIGNAL REPEATER, OPTICAL COMMUNICATION SYSTEM, AND METHOD OF SWITCHING PORT IN OPTICAL SIGNAL REPEATER

(71) Applicant: Sumitomo Electric Industries, Ltd., Osaka-shi, Osaka (JP)

(72) Inventors: Naoya KIZAKI, Osaka-shi, Osaka (JP); Shuitsu YUDA, Osaka-shi, Osaka (JP); Shinya GOTO, Osaka-shi, Osaka (JP)

(73) Assignee: Sumitomo Electric Industries, Ltd., Osaka-shi, Osaka (JP)

(21) Appl. No.: 15/567,640

(22) PCT Filed: Mar. 18, 2016
(86) PCT No.: PCT/JP2016/058754

§ 371 Date: Oct. 19, 2017

(51) Int. Cl. H04Q 11/00; H04B 10/29; H04B 10/40

(52) U.S. Cl. CPC H04Q 11/0067; H04Q 2011/0083; H04B 10/40; H04B 10/29

(57) ABSTRACT

An optical signal repeater includes a plurality of ports, each configured to be connectable to both of a first optical transceiver for transmitting and receiving an optical signal to and from the optical line terminal and a second optical transceiver for transmitting and receiving an optical signal to and from the optical network unit. The optical signal repeater further includes a port switching control unit which switches each of the plurality of ports between a first port adapted to the first optical transceiver and a second port adapted to the second optical transceiver and a path switching unit configured to switch a transmission path between the plurality of ports. The path switching unit includes an aggregation unit configured to aggregate the transmission paths from the second ports. The optical signal repeater further includes a path switching control unit configured to control the path switching unit.

### TECHNICAL FIELD

The present invention relates to an optical signal repeater, an optical communication system, and a method of switching a port in an optical signal repeater.

### BACKGROUND ART

A passive optical network (PON) system represents one type of optical communication systems. The PON system includes an optical line terminal (OLT), one or more optical network units (ONU), an optical fiber for transmission of an optical signal, and an optical splitter branching the optical fiber. The OLT is connected to the ONU through the optical fiber and the optical splitter. The optical splitter is placed between the OLT and the ONU. Thus, a plurality of optical network units can be connected to one optical line terminal.

Japanese Patent Laying-Open No. 2013-048369 (PTD 1) discloses an OLT connected to a plurality of PON lines. The OLT includes first and second optical transmitting and receiving units, first and second access control units, an upper switch, a lower switch, and a fallback control unit. The fallback control unit aggregates output destinations of downstream frames to first and second PON lines into the first access control unit, whereas it distributes output destinations of downstream frames to the first and second optical transmitting and receiving units. The fallback control unit aggregates into the first access control unit by time division multiplexing, output destinations of upstream frames input from the first and second optical transmitting and receiving units to the lower switch.

### CITATION LIST

### Patent Document

PTD 1: Japanese Patent Laying-Open No. 2013-048369

### SUMMARY OF INVENTION

### Technical Problem

A repeater for repeating an optical signal can be disposed between an OLT and an ONU. An optical transceiver is mounted on an OLT side and an ONU side in the repeater. The OLT side and the ONU side are also referred to as a “Trunk side” and a “Leaf side” below, respectively.

In an optical signal repeater, an optical transceiver is connected to a port. The number of ports necessary for the optical signal repeater is a total of the number of optical transceivers mounted on the Trunk side and the number of optical transceivers mounted on the Leaf side.

For example, the optical signal repeater can aggregate paths for upstream signals from a plurality of ONUs. Alternatively, the optical signal repeater can switch communication paths for communication between a plurality of ONUs and a plurality of OLTs. Aggregation or switching of the communication paths described above may herein also be expressed as “Leaf Aggregation.”

Japanese Patent Laying-Open No. 2013-048369 fails to disclose details of Leaf Aggregation. The optical signal repeater is required to be high in degree of freedom in aggregation and switching of communication paths so as to adapt to various forms of connection between OLTs and ONUs.

An object of the present invention is to provide an optical signal repeater high in degree of freedom in aggregation and switching of communication paths, an optical communication system including the optical signal repeater, and a method of switching a port in an optical signal repeater.

### Solution to Problem

An optical signal repeater according to one manner of the present invention includes a plurality of ports. Each of the plurality of ports is configured to be connectable to both of a first optical transceiver for transmitting and receiving an optical signal to and from an optical line terminal and a second optical transceiver for transmitting and receiving an optical signal to and from an optical network unit. The optical signal repeater further includes a port switching control unit which switches each of the plurality of ports between a first port adapted to the first optical transceiver and a second port adapted to the second optical transceiver and a path switching unit configured to switch a transmission path between the plurality of ports in accordance with switching between the first port and the second port. The path switching unit includes an aggregation unit configured to aggregate the transmission paths from the second ports so as to connect the transmission paths to the first ports. The optical signal repeater further includes a path switching control unit configured to control the path switching unit.

An optical communication system according to one manner of the present invention includes an optical line terminal, an optical network unit, an optical communication line, and an optical signal repeater disposed in the optical communication line. The optical signal repeater includes a plurality of ports. Each of the plurality of ports are configured to be connectable to both of a first optical transceiver for transmitting and receiving an optical signal to and from the optical line terminal and a second optical transceiver for transmitting and receiving an optical signal to and from the optical network unit. The optical signal repeater further includes a port switching control unit which switches each of the plurality of ports between a first port adapted to the first optical transceiver and a second port adapted to the second optical transceiver and a path switching unit configured to switch a transmission path between the plurality of ports in accordance with switching between the first port and the second port. The path switching unit includes an aggregation unit configured to aggregate the transmission paths from the second ports so as to connect the transmission paths to the first ports. The optical signal repeater further includes a path switching control unit configured to control the path switching unit.

A method of switching a port in an optical signal repeater according to one manner of the present invention is a method of switching a port included in an optical signal repeater for repeating an optical signal between an optical line terminal and an optical network unit. The port is configured to be connectable to both of a first optical transceiver for transmitting and receiving the optical signal to and from the optical line terminal and a second optical transceiver for transmitting and receiving the optical signal to and from the optical network unit. The method includes obtaining identification information from an optical transceiver connected to the port through the port and switching the port between a first port adapted to the first optical transceiver and a second port adapted to the second optical transceiver based on the identification information.

### Advantageous Effects of Invention

According to the above, an optical signal repeater high in degree of freedom in aggregation and switching of communication paths, an optical communication system including the optical signal repeater, and a method of switching a port in an optical signal repeater can be realized.

### BRIEF DESCRIPTION OF DRAWINGS

FIG. 1 is a diagram showing one example of a configuration of an optical communication system according to one embodiment of the present invention.

FIG. 2 is a block diagram showing a configuration of an optical signal repeater according to one embodiment of the present invention.

FIG. 3 is a diagram showing one example of pin arrangement in a Leaf side optical transceiver and a Trunk side optical transceiver.

FIG. 4 is a block diagram showing one configuration example of an aggregation unit shown in FIG. 2.

FIG. 5 is a block diagram showing a basic configuration of the Trunk side optical transceiver and the Leaf side optical transceiver shown in FIG. 2.

FIG. 6 is a diagram for illustrating repeater of an upstream signal by the optical signal repeater according to an embodiment of the present invention.

FIG. 7 is a signal waveform diagram for illustrating an operation of the aggregation unit.

FIG. 8 is a diagram for illustrating repeater of a downstream signal by the optical signal repeater according to the embodiment of the present invention.

FIG. 9 is a flowchart illustrating a flow of port switching according to the embodiment of the present invention.

FIG. 10 is a block diagram illustrating a configuration for monitoring collision between upstream signals in the optical signal repeater according to the embodiment of the present invention.

FIG. 11 is a flowchart illustrating processing for monitoring collision according to the embodiment of the present invention.

FIG. 12 is a block diagram showing a configuration for reproducing a downstream signal and an upstream signal with a common clock data recovery (CDR) circuit.

FIG. 13 is a diagram showing one example of a configuration of an optical signal repeater for realizing redundant switching between optical transceivers.

### DESCRIPTION OF EMBODIMENTS

### Description of Embodiments of Present Invention

Embodiments of the present invention will initially be listed and described.

(1) An optical signal repeater according to one manner of the present invention includes a plurality of ports. Each of the plurality of ports is configured to be connectable to both of a first optical transceiver for transmitting and receiving an optical signal to and from an optical line terminal and a second optical transceiver for transmitting and receiving an optical signal to and from an optical network unit. The optical signal repeater further includes a port switching control unit which switches each of the plurality of ports between a first port adapted to the first optical transceiver and a second port adapted to the second optical transceiver and a path switching unit configured to switch a transmission path between the plurality of ports in accordance with switching between the first port and the second port. The path switching unit includes an aggregation unit configured to aggregate the transmission paths from the second ports so as to connect the transmission paths to the first ports. The optical signal repeater further includes a path switching control unit configured to control the path switching unit.

According to the above, an optical signal repeater high in degree of freedom in aggregation and switching of communication paths can be realized. Each of the plurality of ports can be set to any of a first port (a Trunk port) and a second port (a Leaf port). The optical signal repeater can realize various forms of connection between an optical line terminal and an optical network unit. A degree of freedom in Leaf Aggregation can thus be enhanced.

(2) In the optical signal repeater described in (1), each of the first optical transceiver and the second optical transceiver stores identification information. When at least one of the plurality of ports is connected to the first optical transceiver or the second optical transceiver, the port switching control unit obtains the identification information through the at least one port and identifies an optical transceiver connected to the at least one port.

According to the above, without external control, the optical signal repeater can identify an optical transceiver as the first optical transceiver (the Trunk side optical transceiver) or the second optical transceiver (the Leaf side optical transceiver).

(3) In the optical signal repeater described in (1) or (2), the port switching control unit switches the at least one port between the first port and the second port based on the identification information obtained by the port switching control unit.

According to the above, without external control, the optical signal repeater can switch a port connected to an optical transceiver between the first port and the second port.

(4) In the optical signal repeater in any of (1) to (3), the aggregation unit generates a continuous signal by inserting an idle pattern between two upstream signals.

According to the above, since the first optical transceiver allows continuous transmission and continuous reception, flexibility in design of the optical signal repeater can be enhanced.

(5) In the optical signal repeater in any of (1) to (4), the path switching unit includes a distribution unit for distributing a downstream signal from the first optical transceiver to the second ports.

According to the above, a signal (a downstream signal) from an optical line terminal can be distributed to a plurality of second optical transceivers with a simplified configuration.

(6) In the optical signal repeater in any of (1) to (5), a plurality of optical transceivers are connected to the plurality of ports, respectively. The plurality of optical transceivers include the first optical transceiver, the second optical transceiver, and at least one of a spare first optical transceiver to which switching can be made from the first optical transceiver and a spare second optical transceiver to which switching can be made from the second optical transceiver.

According to the above, signals (downstream signals) from a plurality of optical line terminals can be distributed to a plurality of second optical transceivers with a simplified configuration.

(7) In the optical signal repeater in any of (1) to (6), the second optical transceiver detects reception of an optical signal by the second optical transceiver itself and outputs a detection signal indicating a result of detection. The optical signal repeater further includes a collision monitoring unit configured to monitor collision between the detection signals.

According to the above, whether or not a plurality of upstream signals collide against each other can be monitored.

(8) In the optical signal repeater in any of (1) to (7), the first optical transceiver outputs a continuous signal to the path switching unit upon receiving a downstream signal. The second optical transceiver outputs a burst signal to the path switching unit upon receiving an upstream signal. The optical signal repeater further includes a signal reproduction unit configured to be able to reproduce the continuous signal and the burst signal.

According to the above, since the signal reproduction unit can be used for reproduction of both of a continuous signal and a burst signal, the number of components can be reduced.

(9) An optical communication system according to one manner of the present invention includes an optical line terminal, an optical network unit, an optical communication line, and an optical signal repeater disposed in the optical communication line. The optical signal repeater includes a plurality of ports. Each of the plurality of ports is configured to be connectable to both of a first optical transceiver for transmitting and receiving an optical signal to and from the optical line terminal and a second optical transceiver for transmitting and receiving an optical signal to and from the optical network unit. The optical signal repeater further includes a port switching control unit which switches each of the plurality of ports between a first port adapted to the first optical transceiver and a second port adapted to the second optical transceiver and a path switching unit configured to switch a transmission path between the plurality of ports in accordance with switching between the first port and the second port. The path switching unit includes an aggregation unit configured to aggregate the transmission paths from the second ports so as to connect the transmission paths to the first ports. The optical signal repeater further includes a path switching control unit configured to control the path switching unit.

According to the above, an optical communication system high in degree of freedom in aggregation and switching of communication paths can be realized.

(10) A method of switching a port included in an optical signal repeater for repeating an optical signal between an optical line terminal and an optical network unit is provided. The port is configured to be connectable to both of a first optical transceiver for transmitting and receiving the optical signal to and from the optical line terminal and a second optical transceiver for transmitting and receiving the optical signal to and from the optical network unit. The method includes obtaining identification information from an optical transceiver connected to the port through the port and switching the port between a first port adapted to the first optical transceiver and a second port adapted to the second optical transceiver based on the identification information.

According to the above, aggregation and switching of communication paths between an optical line terminal and an optical network unit can be carried out with a high degree of freedom.

### Details of Embodiments of Present Invention

Embodiments of the present invention will be described hereinafter with reference to the drawings. The same or corresponding elements in the drawings have the same reference numerals allotted and description thereof will not be repeated. The term “connection” in the description below is used to mean connection in such a manner that a signal can be transmitted and received. Therefore, “connection” is not limited to mechanical connection.

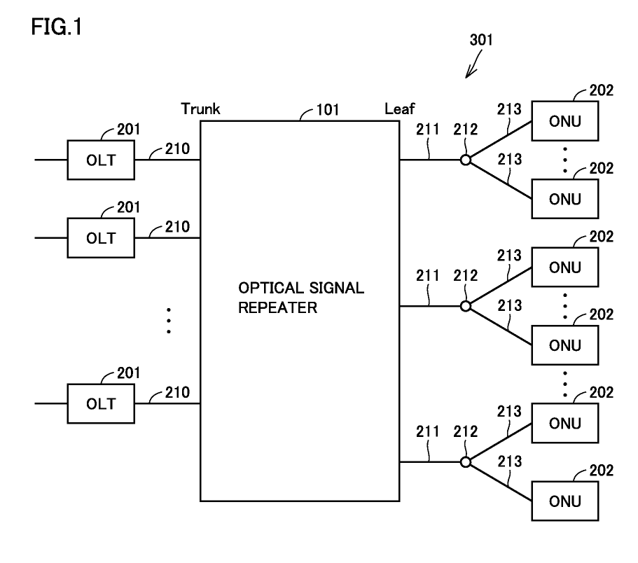

FIG. 1 is a diagram showing one example of a configuration of an optical communication system according to one embodiment of the present invention. As shown in FIG. 1, an optical communication system 301 is a PON system, and it is adapted, for example, to gigabit Ethernet™ (GE)-PON or 10G-Ethernet™ PON (EPON), or both of them. Optical communication system 301 includes at least one OLT 201 connected to an upper network, an optical signal repeater 101, at least one ONU 202, optical fibers 210, 211, and 213, and an optical coupler 212.

Each optical fiber 211 is connected to OLT 201. Each optical fiber 213 is connected to corresponding ONU 202. Optical coupler 212 connects optical fiber 211 and optical fiber 213 to each other. Optical fibers 210, 211, and 213 and optical coupler 212 constitute an optical communication line of optical communication system 301.

Optical signal repeater 101 is connected to optical fiber 210 and optical fiber 211. Optical signal repeater 101 repeats an optical signal (a downstream signal) from OLT 201 to ONU 202 and repeats an optical signal (an upstream signal) from ONU 202 to OLT 201. An OLT side may hereinafter be called a “Trunk side” and an ONU side may be called a “Leaf side.” The Trunk side and the Leaf side are denoted as “Trunk” and “Leaf” in FIG. 1, respectively.

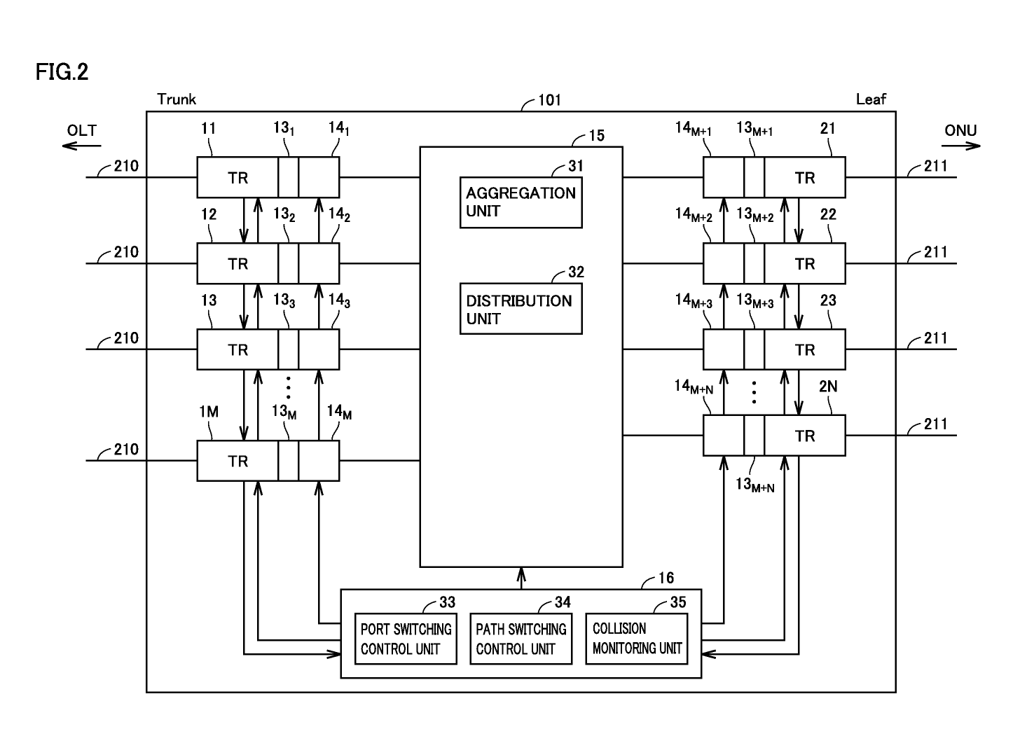

FIG. 2 is a block diagram showing a configuration of the optical signal repeater according to one embodiment of the present invention. As shown in FIG. 2, optical signal repeater 101 includes M (M being an integer not smaller than 1) Trunk side optical transceivers connected to respective M optical fibers 210, N (N being an integer not smaller than 1) Leaf side optical transceivers connected to respective N optical fibers 211, and (M+N) ports. In FIG. 2 and subsequent figures which will be described later, an optical transceiver is denoted as “TR”.

The (M+N) ports are identical to one another in configuration. Combination between M and N is determined in accordance with a configuration of optical communication system 301. Though the sum of M and N is, for example, sixteen, limitation thereto is not intended.

Each of the (M+N) ports is configured to be connectable to any of the Trunk side optical transceivers and the Leaf side optical transceivers. Each optical transceiver is configured to be pluggable into a port. As will be described later, the optical transceiver includes a plurality of pins. Each port can receive an input and provide an output of a signal from and to a corresponding optical transceiver by being connected to a plurality of pins of the optical transceiver.

Specifically, optical signal repeater 101 includes Trunk side optical transceivers 11, 12, 13, . . . , and 1M, Leaf side optical transceivers 21, 22, 23, . . . , and 2N, ports 13₁, 13₂, 13₃, . . . , 13_{M}, 13_{M+1}, 13_{M+2}, 13_{M+3}, . . . , and 13_{M+N}, port switching circuits 14₁, 14₂, 14₃, . . . , 14_{M}, 14_{M+1}, 14_{M+2}, 14_{M+3}, . . . , and 14_{M+N}, a path switching unit 15, and a control unit 16. Each of Trunk side optical transceivers 11, 12, 13, . . . , and 1M is configured to be able to receive a continuous optical signal from corresponding optical fiber 210 and to transmit a continuous optical signal to corresponding optical fiber 210. Each of Leaf side optical transceivers 21, 22, 23, . . . , and 2N is configured to be able to receive a burst optical signal from corresponding optical fiber 210 and to transmit a continuous optical signal to corresponding optical fiber 210. Each optical transceiver can convert an optical signal into an electric signal and vice versa.

Each port functions as an input/output interface of data. Ports 13₁, 13₂, 13₃, . . . , and 13_{M} of the (M+N) ports are connected to respective Trunk side optical transceivers 11, 12, 13, . . . , and 1M. Ports 13_{M+1}, 13_{M+2}, 13_{M+3}, . . . , and 13_{M+N} are connected to respective Leaf side optical transceivers 21, 22, 23, . . . , and 2N.

Each of port switching units 14₁, 14₂, 14₃, . . . , 14_{M}, 14_{M+1}, 14_{M+}2, 14_{M+3}, . . . , and 14_{M+N} adapts a corresponding port to an optical transceiver connected to that port. When a Trunk side optical transceiver is connected to a port, that port receives a continuous signal (a downstream signal) from the Trunk side optical transceiver and outputs a continuous signal (an upstream signal) to the Trunk side optical transceiver. When a Leaf side optical transceiver is connected to the same port, that port receives a burst signal (an upstream signal) from the Leaf side optical transceiver and outputs a continuous signal (a downstream signal) to the Leaf side optical transceiver. Each of port switching units 14₁, 14₂, . . . , 14_{M}, 14_{M+1}, 14_{M+2}, . . . , and 14_{M+N} switches a function of a corresponding port between the first port (Trunk port) adapted to the Trunk side optical transceiver and the second port (the Leaf port) adapted to the Leaf side optical transceiver.

Path switching unit 15 switches signal transmission paths between a plurality of Trunk side optical transceivers and a plurality of Leaf side optical transceivers. Path switching unit 15 includes an aggregation unit 31 and a distribution unit 32.

Aggregation unit 31 aggregates a plurality of transmission paths (communication paths) from Leaf side optical transceivers 21, 22, . . . , and 2N. Distribution unit 32 distributes a downstream signal transmitted from at least one of Trunk side optical transceivers 11, 12, . . . , and 1M to Leaf side optical transceivers 21, 22, . . . , and 2N through ports 13_{M+1}, 13_{M+2}, 13_{M+3}, . . . , and 13_{M+N}.

A configuration of aggregation unit 31 and distribution unit 32 for achieving the function described above is not limited. Path switching unit 15 can be implemented, for example, by a field programmable gate array (FPGA). Aggregation unit 31 may include, for example, a logic circuit.

Distribution unit 32 may be implemented, for example, by a logic circuit. Distribution unit 32 copies a downstream signal from a Trunk side optical transceiver and generates a plurality of identical downstream signals. Distribution unit 32 distributes the plurality of downstream signals to a plurality of Leaf side optical transceivers. Distribution unit 32, however, is not limited to a unit implemented by a logic circuit. For example, distribution unit 32 may be implemented by a line for branching a signal. With distribution unit 32, optical signal repeater 101 can realize distribution of a signal (downstream signal) from OLT 201 to a plurality of Leaf side optical transceivers with a simplified configuration.

Control unit 16 controls optical signal repeater 101 in a centralized manner. Control unit 16 can be implemented, for example, by a central processing unit (CPU).

Control unit 16 includes a port switching control unit 33, a path switching control unit 34, and a collision monitoring unit 35. Port switching control unit 33 controls each of port switching units 14₁, 14₂, 14₃, . . . , 14_{M}, 14_{M+1}, 14_{M+2}, 14_{M+3}, . . . , and 14_{M+N}.

Port switching control unit 33 identifies an optical transceiver connected to each port as any of a Trunk side optical transceiver and a Leaf side optical transceiver. Port switching control unit 33 controls each port switching unit based on a result of identification. Path switching control unit 34 controls path switching unit 15. Leaf Aggregation can thus be implemented.

Collision monitoring unit 35 monitors whether or not burst signals output from Leaf side optical transceivers 21, 22, . . . , and 2N collide against each other. Each of Leaf side optical transceivers 21, 22, 23, . . . , and 2N receives an optical burst signal from an ONU. When each Leaf side optical transceiver receives an optical burst signal, it outputs a reception detection signal.

Timing of transmission of a burst signal from each ONU is basically controlled by an OLT. The OLT designates timing to transmit a burst signal to each ONU such that burst signals transmitted from ONUS do not temporally overlap (do not collide) with each other. When some kind of abnormal condition occurs in optical communication system 301, however, two burst optical signals may collide against each other. Collision monitoring unit 35 monitors whether or not burst signals collide against each other based on a reception detection signal output from each of Leaf side optical transceivers 21, 22, . . . , and 2N.

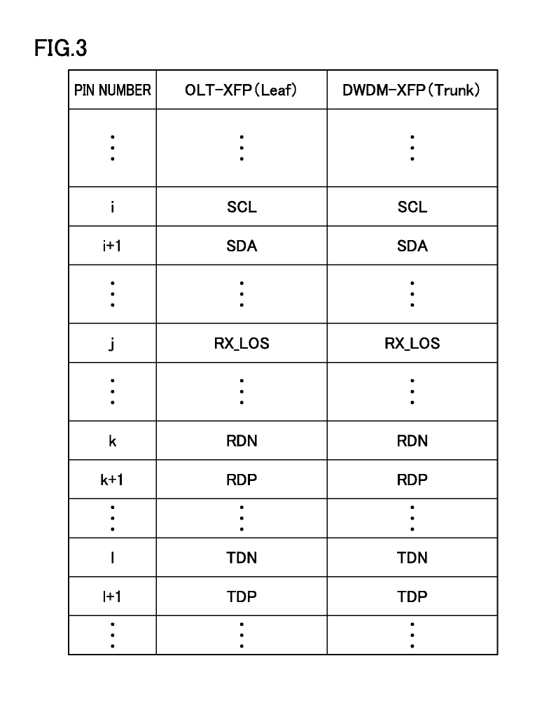

Port switching according to an embodiment of the present invention will be described below in detail. FIG. 3 is a diagram showing one example of pin arrangement in a Leaf side optical transceiver and a Trunk side optical transceiver. In this embodiment, each of the Leaf side optical transceiver and the Trunk side optical transceiver may be, for example, an optical transceiver in conformity with 10 Gigabit small Form-factor Pluggable (XFP). Pin assignment in each of the Leaf side optical transceiver and the Trunk side optical transceiver may be determined in accordance with multi-source agreement (MSA).

As shown in FIG. 3, pin assignment is at least partially common between a Leaf side optical transceiver (OLT-XFP) and a Trunk side optical transceiver (DWDM-XFP). i, j, k, and l are any positive integers.

The Trunk side and the Leaf side may be different from each other in type of an optical transceiver. As shown in FIG. 3, for example, in an optical signal repeater adapted to 10G-EPON, dense wavelength division multiplexing (DWDM)-10 Gigabit Small Form Factor Pluggable (XFP) is mounted on the Trunk side and OLT-XFP is mounted on the Leaf side.

An ith pin and an i+1th pin are pins for data communication under I2C. The ith pin is a pin for a clock signal (SCL), and the (i+1)th pin is a pin for a data signal (SDA). A jth pin is a pin for outputting a result of detection of a reception signal. A kth pin and a k+1th pin are pins for outputting a signal received by an optical transceiver from the optical transceiver. An lth pin and an l+1th pin are signal input pins of the optical transceiver.

In this embodiment, each of a signal output from an optical transceiver and a signal input to an optical transceiver are differential signals constituted of a pair of two signals. Two signals (RDN, RDP) constituting a reception signal are assigned to the kth pin and the k+1th pin, respectively. Two signals (TDN, TDP) constituting a transmission signal are assigned to the lth pin and the l+1th pin, respectively.

A signal assigned to a pin other than the above may be different between the Leaf side optical transceiver and the Trunk side optical transceiver. Each port switching unit adapts a corresponding port to an optical transceiver connected to that port. Thus, even though the Leaf side optical transceiver and the Trunk side optical transceiver are different from each other in pin assignment, each port can be adapted to both of the Trunk side optical transceiver and the Leaf side optical transceiver. Each port has compatibility.

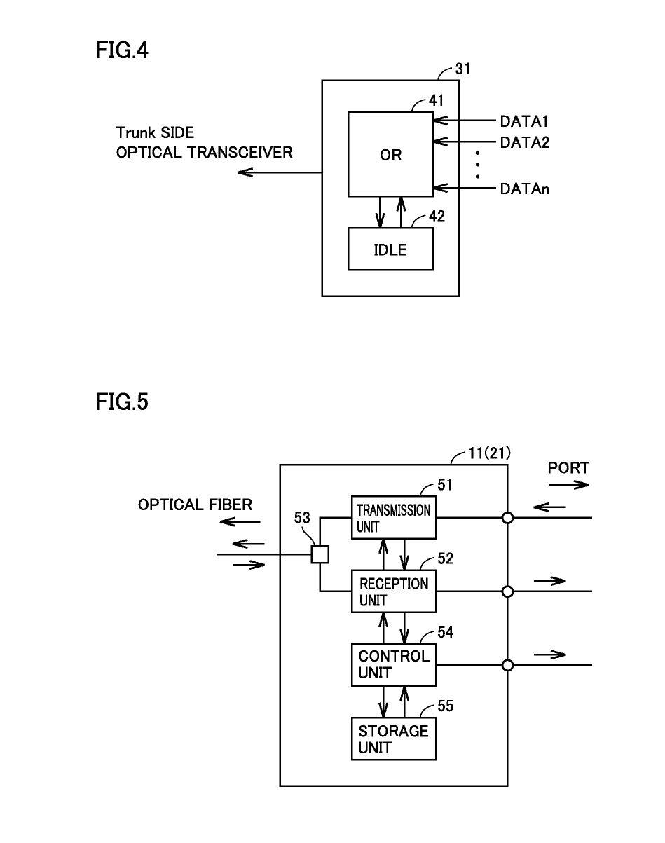

FIG. 4 is a block diagram showing one configuration example of aggregation unit 31 shown in FIG. 2. As shown in FIG. 4, aggregation unit 31 can include an OR circuit 41 and an idle pattern generation circuit 42. OR circuit 41 receives data signals DATA1, DATA2, . . . , and DATAn sent from respective N Leaf side optical transceivers and generates a logical sum of the data signals. Idle pattern generation circuit 42 generates a continuous signal by inserting an idle pattern between two data signals.

FIG. 5 is a block diagram showing a basic configuration of the Trunk side optical transceiver and the Leaf side optical transceiver shown in FIG. 2. Trunk side optical transceiver 11 includes a transmission unit 51, a reception unit 52, a fiber connection unit 53, a control unit 54, and a storage unit 55.

Transmission unit 51 receives an electric signal through a port and converts the electric signal into an optical signal. Transmission unit 51 outputs the optical signal to an optical fiber.

Reception unit 52 receives an optical signal through an optical fiber and converts the optical signal into an electric signal. Reception unit 52 outputs the electric signal to a port.

Fiber connection unit 53 optically connects transmission unit 51 and reception unit 52 to an optical fiber. Fiber connection unit 53 allows transmission of an optical signal from transmission unit 51 to an optical fiber and reception of an optical signal from an optical fiber to reception unit 52.

Control unit 54 controls transmission unit 51 and reception unit 52. Control unit 54 monitors Trunk side optical transceiver 11 and outputs a result of monitoring to a port. Control unit 54 outputs identification information for identifying Trunk side optical transceiver 11 to a port. For example, in response to a request from control unit 16 shown in FIG. 2, control unit 54 outputs identification information.

Storage unit 55 stores identification information in a non-volatile manner. A type of identification information is not particularly limited. For example, identification information may be a serial ID.

Since a configuration of Leaf side optical transceiver 21 is basically the same as the configuration shown in FIG. 5, subsequent description will not be repeated. A Leaf side optical transceiver stores identification information for identifying the Leaf side optical transceiver and outputs the identification information in response to a request from control unit 16 shown in FIG. 2.

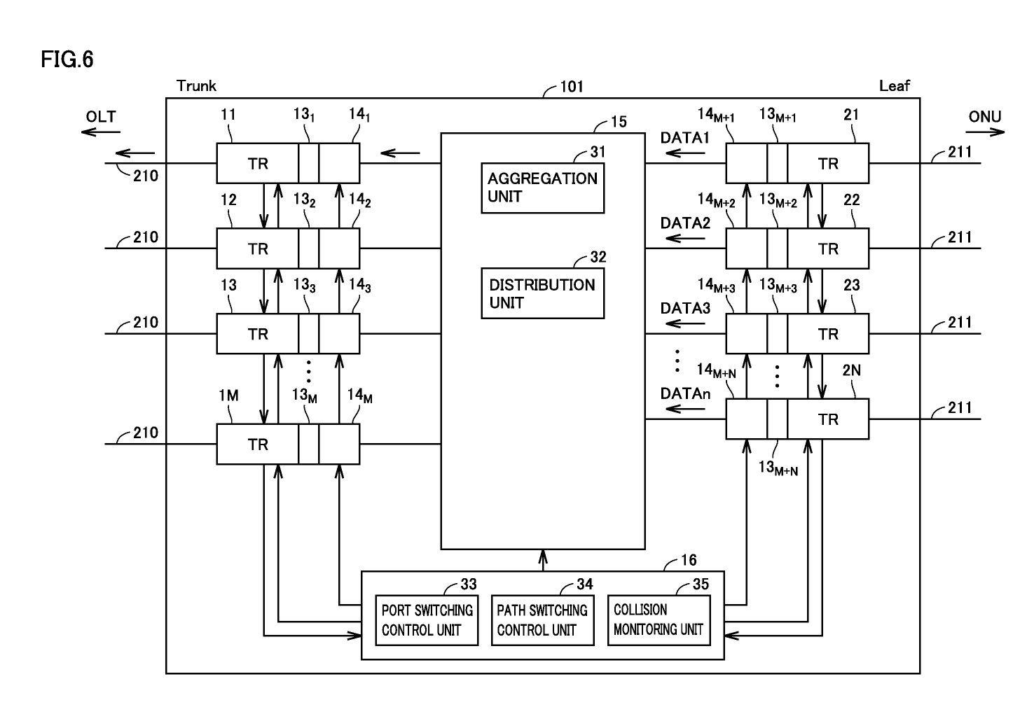

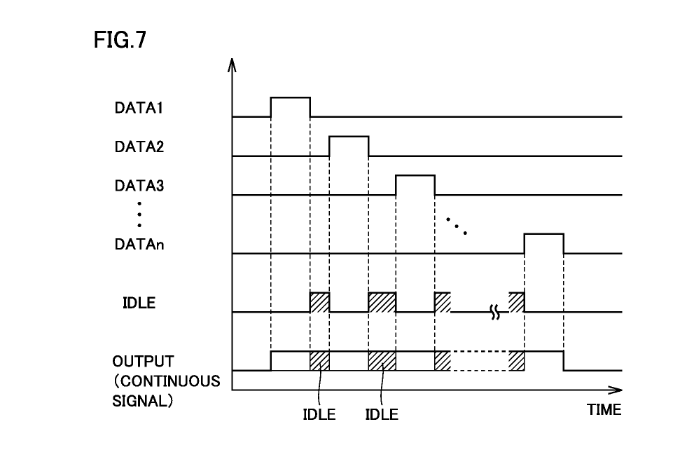

FIG. 6 is a diagram for illustrating repeater of an upstream signal by the optical signal repeater according to the embodiment of the present invention. FIG. 7 is a signal waveform diagram for illustrating an operation of aggregation unit 31.

As shown in FIGS. 6 and 7, Leaf side optical transceivers 21, 22, . . . , and 2N output data signals DATA1, DATA2, . . . , and DATAn, respectively. Each data signal corresponds to a burst signal sent from a corresponding ONU. Aggregation unit 31 generates a logical sum of the data signals.

OLT 201 indicates timing of transmission of burst signals to ONUs 202 such that a plurality of burst signals do not temporally overlap. Normally, data signals DATA1, DATA2, . . . , and DATAn do not temporally overlap. Aggregation unit 31 generates a continuous signal by inserting an idle pattern IDLE between two data signals. The continuous signal is sent to a Trunk side optical transceiver. For example, Trunk side optical transceiver 11 transmits the continuous signal to optical fiber 210. Since the Trunk side optical transceiver allows continuous transmission and continuous reception, flexibility in design of optical signal repeater 101 can be enhanced.

Aggregation unit 31 aggregates a plurality of communication paths for upstream signals. A destination of aggregation is at least one of Trunk side optical transceivers 11, 12, . . . , and 1M. The destination of aggregation is not limited to a single Trunk side optical transceiver. The destination of aggregation may be two or more Trunk side optical transceivers.

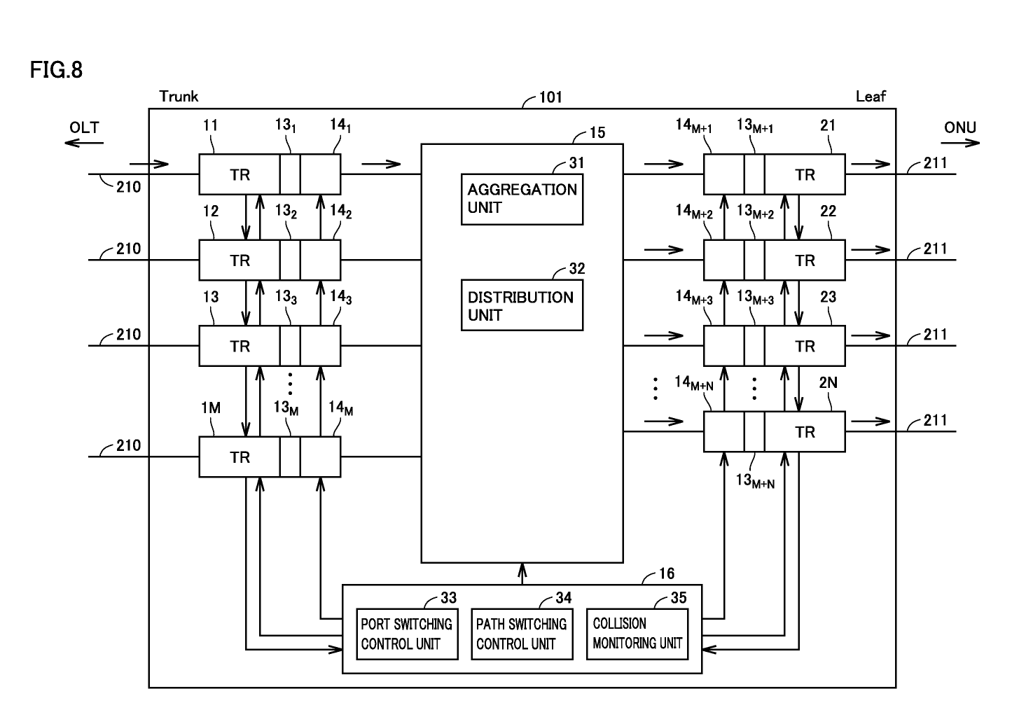

FIG. 8 is a diagram for illustrating repeater of a downstream signal by the optical signal repeater according to the embodiment of the present invention. As shown in FIG. 8, for example, Trunk side optical transceiver 11 receives a downstream signal from corresponding OLT 201. Trunk side optical transceiver 11 outputs the downstream signal to path switching unit 15. In path switching unit 15, distribution unit 32 distributes the downstream signal from Trunk side optical transceiver 11 to Leaf side optical transceivers 21, 22, . . . , and 2N. Each Leaf side optical transceiver transmits the downstream signal to optical fiber 211.

Referring back to FIG. 2, control unit 16 reads identification information from each of Trunk side optical transceivers 11, 12, . . . , and 1M and Leaf side optical transceivers 21, 22, . . . , and 2N. Thus, control unit 16 identifies an optical transceiver connected to each port as the Trunk side optical transceiver or the Leaf side optical transceiver. Control unit 16 sets a port in accordance with a result of identification. This processing is hereinafter called “port switching.”

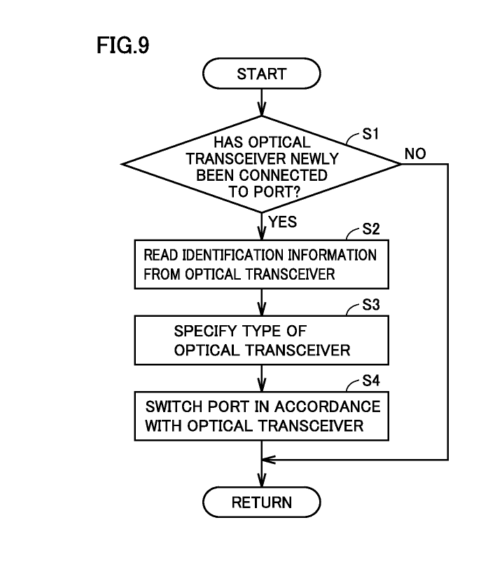

FIG. 9 is a flowchart illustrating a flow of port switching according to the embodiment of the present invention. Processing in this flowchart may be performed for each port. As shown in FIG. 9, when the process is started, port switching control unit 33 determines in step S1 whether or not an optical transceiver has newly been connected to a port. A determination method is not particularly limited. For example, with the use of I2C communication described above, port switching control unit 33 may obtain information indicating that an optical transceiver has been connected to a port from the optical transceiver.

When an optical transceiver is newly connected to a port (YES in step S1), the process proceeds to step S2. When an optical transceiver has already been connected to a port or when no optical transceiver is connected to a port (NO in step S1), subsequent processing is not performed.

In step S2, port switching control unit 33 reads identification information from the optical transceiver.

In step S3, port switching control unit 33 identifies a type of the optical transceiver based on identification information thereof. When a serial ID is employed as the identification information, port switching control unit 33 may store information for associating the serial ID with a Trunk side optical transceiver or a Leaf side optical transceiver. The information may be stored in optical signal repeater 101, for example, in a form of a database.

In step S4, port switching control unit 33 makes port switching in accordance with the identified type of the optical transceiver. Specifically, port switching control unit 33 controls the port switching unit. Thus, the port is adapted to a Trunk side optical transceiver or a Leaf side optical transceiver.

According to the embodiment of the present invention, optical signal repeater 101 can identify an optical transceiver as a first optical transceiver (a Trunk side optical transceiver) or a second optical transceiver (Leaf side optical transceiver) without external control. Furthermore, optical signal repeater 101 can switch a port connected to an optical transceiver between a first port (a Trunk port) and a second port (a Leaf port) without external control.

In the embodiment of this invention, when a Leaf side optical transceiver receives an upstream signal, the Leaf side optical transceiver outputs a reception detection signal. Control unit 16 monitors collision between upstream signals based on a reception detection signal from the Leaf side optical transceiver.

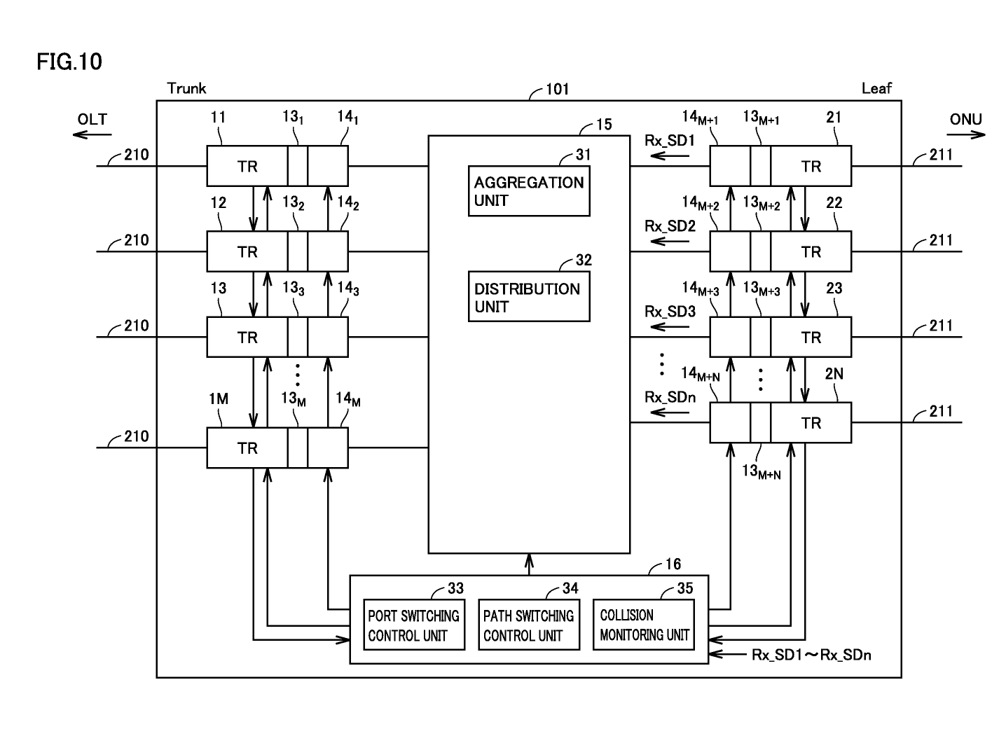

FIG. 10 is a block diagram illustrating a configuration for monitoring collision between upstream signals in the optical signal repeater according to the embodiment of the present invention. As shown in FIG. 10, collision monitoring unit 35 is configured to receive reception detection signals Rx_SD1, Rx_SD2, . . . , and Rx_SDn from respective Leaf side optical transceivers 21, 22, 23, . . . , and 2N. When two or more reception detection signals temporally overlap (that is, collide) with each other, collision monitoring unit 35 detects collision between upstream signals.

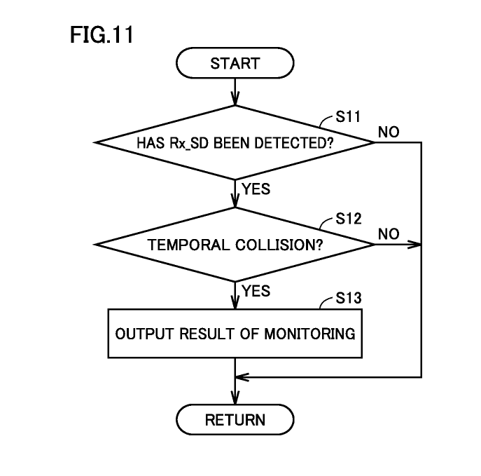

FIG. 11 is a flowchart illustrating processing for monitoring collision according to the embodiment of the present invention. As shown in FIG. 11, in step S11, collision monitoring unit 35 determines whether it has detected any of reception detection signals Rx_SD1, . . . , and Rx_SDn. In FIG. 11, “Rx_SD” represents any of reception detection signals Rx_SD1, . . . , and Rx_SDn. When any of reception detection signals Rx_SD1, . . . , and Rx_SDn is input to collision monitoring unit 35, collision monitoring unit 35 determines that it has detected any of reception detection signals Rx_SD1, . . . , and Rx_SDn. In this case (YES in step S11), the process proceeds to step S12. When none of reception detection signals Rx_SD1, . . . , and Rx_SDn has been detected (NO in step S11), the process ends.

In step S12, collision monitoring unit 35 determines whether or not two or more reception detection signals temporally collide against each other. When two or more reception detection signals have collided against each other (YES in step S12), collision monitoring unit 35 outputs in step S13 a result of monitoring indicating collision between the reception detection signals. When there is no collision between two or more reception detection signals (NO in step S12), the process ends. Collision monitoring unit 35 may output a result of monitoring indicating that no collision between reception detection signals has occurred.

A downstream signal and an upstream signal may be reproduced by different clock data recovery (CDR) circuits. As will be described below, however, in the embodiment of this invention, a common CDR circuit can reproduce a downstream signal and an upstream signal.

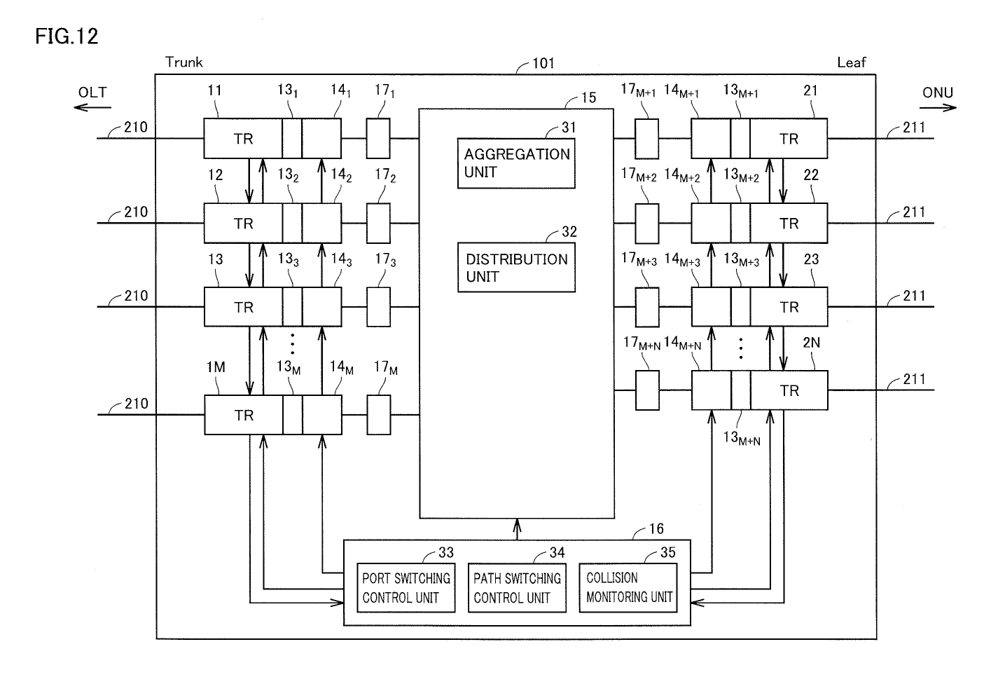

FIG. 12 is a block diagram showing a configuration for reproducing a downstream signal and an upstream signal with a common CDR circuit. As shown in FIG. 12, optical signal repeater 101 further includes CDR circuits 17₁ to 17_{M+N} allocated to respective ports 13₁ to 13_{M+N}. As a result of port switching, a signal received by the port switches between a downstream signal (continuous signal) and an upstream (burst signal). Each of CDR circuits 17₁ to 17_{M+N} can reproduce any of a downstream signal and an upstream signal. Each CDR circuit can commonly be used for reproduction of both of a downstream signal and an upstream signal.

As a common CDR circuit reproduces a downstream signal and an upstream signal, the number of components constituting optical signal repeater 101 can be reduced. A CDR circuit may be synchronized with a downstream signal from an OLT and an ONU may generate an upstream signal synchronized with the downstream signal. In this case, the upstream signal and the downstream signal are identical in frequency, although there is a phase difference therebetween. Therefore, a clock can be adjusted by adjusting the upstream signal only in phase difference by using a CDR circuit.

Some of optical transceivers connected to ports may stand by as spare optical transceivers. According to such a configuration, when an operating optical transceiver fails, redundant switching between the failed optical transceiver and a stand-by optical transceiver can be made.

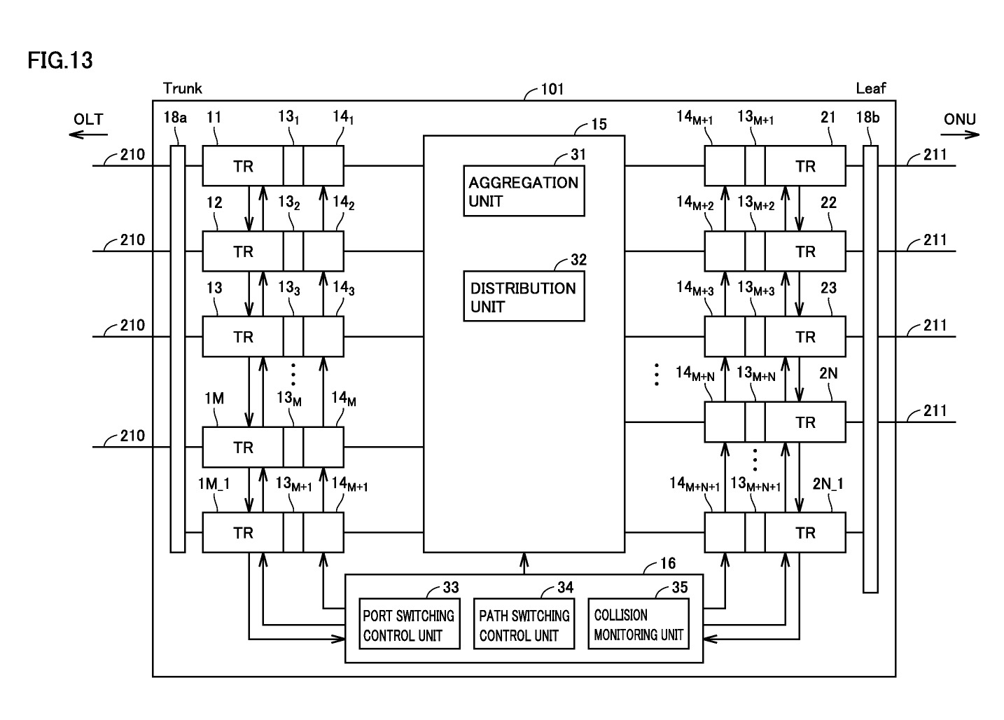

FIG. 13 is a diagram showing one example of a configuration of an optical signal repeater for realizing redundant switching between optical transceivers. In the configuration shown in FIG. 13, optical signal repeater 101 further includes switches 18a and 18b and a spare optical transceiver. In FIG. 13, a Trunk side optical transceiver 1M_1 and a Leaf side optical transceiver 2N_1 are spare optical transceivers.

Optical signal repeater 101 includes a port 13_{M+1} and a port 13_{M+N1} and a port switching unit 14_{M+1} and a port switching unit 14_{M+N+1}. Trunk side optical transceiver 1M_1 is connected to port 13_{M+1}. Leaf side optical transceiver 2N_1 includes port 13_{M+N1}, port switching unit 14_{M+1} for switching a function of port 13_{M+1}, and a port switching unit 14_{M+N+1} for switching a function of port 13_{M+N+1}.

Switch 18a switches among communication paths between M optical fibers 210 and M Trunk side optical transceivers. Switch 18b switches among communication paths between N optical fibers 211 and N Leaf side optical transceivers. Switches 18a and 18b may be controlled by control unit 16.

When any one of Trunk side optical transceivers 11, 12, . . . , and 1M fails, switch 18a disconnects the failed optical transceiver and optical fiber 210 from each other and connects optical fiber 210 to Trunk side optical transceiver 1M_1. When any one of Leaf side optical transceivers 21, 22, . . . , and 2N fails, switch 18b disconnects the failed optical transceiver and optical fiber 211 from each other and connects optical fiber 211 to Leaf side optical transceiver 2N_1.

The number of spare Trunk side optical transceivers and the number of spare Leaf side optical transceivers may both be set to two or more. Any one of the spare Trunk side optical transceiver and the spare Leaf side optical transceiver may be included in optical signal repeater 101.

As set forth above, according to the embodiment of the present invention, switching between a Leaf side optical transceiver port and a Trunk side optical transceiver port can freely be made. An optical signal repeater which can be higher in degree of freedom in aggregation on a Leaf side can thus be realized.

It should be understood that the embodiment disclosed herein is illustrative and non-restrictive in every respect. The scope of the present invention is defined by the terms of the claims, rather than the embodiment above, and is intended to include any modifications within the scope and meaning equivalent to the terms of the claims.

### REFERENCE SIGNS LIST

11 to 1M Trunk side optical transceiver; 21 to 2N Leaf side optical transceiver; 13₁ to 13_{M+N} port; 14₁ to 14_{M+N} port switching unit; 15 path switching unit; 16 control unit (optical signal repeater); 17₁ to 17_{M+N} CDR circuit; 18a, 18b switch; 31 aggregation unit; 32 distribution unit; 33 port switching control unit; 34 path switching control unit; 35 collision monitoring unit; 41 OR circuit; 42 idle pattern generation circuit; 51 transmission unit; 52 reception unit; 53 fiber connection unit; 54 control unit (optical transceiver); 55 storage unit; 61, 62 reproduction unit; 101 optical signal repeater; 210, 211, 213 optical fiber; 212 optical coupler; 301 optical communication system; DATA1 to DATAn data signal; IDLE idle pattern; Rx_SD1 to Rx_SDn reception detection signal; and S1 to S4, S11 to S13 step

1. An optical signal repeater for repeating an optical signal between an optical line terminal and an optical network unit, the optical signal repeater comprising:
a plurality of ports, each of the plurality of ports being configured to be connectable to both of a first optical transceiver for transmitting and receiving the optical signal to and from the optical line terminal and a second optical transceiver for transmitting and receiving the optical signal to and from the optical network unit;
a port switching control unit which switches each of the plurality of ports between a first port adapted to the first optical transceiver and a second port adapted to the second optical transceiver;
a path switching unit configured to switch a transmission path between the plurality of ports in accordance with switching between the first port and the second port, the path switching unit including an aggregation unit configured to aggregate the transmission paths from the second ports so as to connect the transmission paths to the first ports; and
a path switching control unit configured to control the path switching unit.

2. The optical signal repeater according to claim 1, wherein
each of the first optical transceiver and the second optical transceiver stores identification information, and
when at least one of the plurality of ports is connected to the first optical transceiver or the second optical transceiver, the port switching control unit obtains the identification information through the at least one port and identifies an optical transceiver connected to the at least one port.

3. The optical signal repeater according to claim 2, wherein
the port switching control unit switches the at least one port between the first port and the second port based on the identification information obtained by the port switching control unit.

4. The optical signal repeater according to claim 1, wherein
the aggregation unit generates a continuous signal by inserting an idle pattern between two upstream signals.

5. The optical signal repeater according to claim 1, wherein
the path switching unit includes a distribution unit for distributing a downstream signal from the first optical transceiver to the second ports.

6. The optical signal repeater according to claim 1, wherein
a plurality of optical transceivers are connected to the plurality of ports, respectively,
the plurality of optical transceivers include
the first optical transceiver,
the second optical transceiver, and
at least one of a spare first optical transceiver to which switching can be made from the first optical transceiver and a spare second optical transceiver to which switching can be made from the second optical transceiver.

7. The optical signal repeater according to claim 1, wherein
the second optical transceiver detects reception of an optical signal by the second optical transceiver itself and outputs a detection signal indicating a result of detection, and
the optical signal repeater further comprises a collision monitoring unit configured to monitor collision between the detection signals.

8. The optical signal repeater according to claim 1, wherein
the first optical transceiver outputs a continuous signal to the path switching unit upon receiving a downstream signal,
the second optical transceiver outputs a burst signal to the path switching unit upon receiving an upstream signal, and
the optical signal repeater further comprises a signal reproduction unit configured to be able to reproduce the continuous signal and the burst signal.

9. An optical communication system comprising:
an optical line terminal;
an optical network unit;
an optical communication line; and
an optical signal repeater disposed in the optical communication line,
the optical signal repeater including
a plurality of ports, each of the plurality of ports being configured to be connectable to both of a first optical transceiver for transmitting and receiving an optical signal to and from the optical line terminal and a second optical transceiver for transmitting and receiving an optical signal to and from the optical network unit,
a port switching control unit which switches each of the plurality of ports between a first port adapted to the first optical transceiver and a second port adapted to the second optical transceiver,
a path switching unit configured to switch a transmission path between the plurality of ports in accordance with switching between the first port and the second port, the path switching unit including an aggregation unit configured to aggregate the transmission paths from the second ports so as to connect the transmission paths to the first ports, and
a path switching control unit configured to control the path switching unit.

10. A method of switching a port included in an optical signal repeater for repeating an optical signal between an optical line terminal and an optical network unit, the port being configured to be connectable to both of a first optical transceiver for transmitting and receiving the optical signal to and from the optical line terminal and a second optical transceiver for transmitting and receiving the optical signal to and from the optical network unit, the method comprising:
obtaining identification information from an optical transceiver connected to the port through the port; and
switching the port between a first port adapted to the first optical transceiver and a second port adapted to the second optical transceiver based on the identification information.
